(19) United States
(12) Patent Application Publication
(10) Pub. No.: US 2026/0109014 A1
(43) Pub. Date: Apr. 23, 2026

(54) SCREWDRIVER

(71) Applicant: TECHTRONIC CORDLESS GP, Anderson, SC (US)

(72) Inventors: Rony C. Chan, Simpsonville, SC (US); De Sheng XIE, Dongguan City (CN)

(21) Appl. No.: 18/923,383

(22) Filed: Oct. 22, 2024

(51) Int. Cl. B25G 1/08; B25B 15/02; B25B 23/00

(52) U.S. Cl. CPC B25G 1/085; B25B 15/02; B25B 23/0035

(57) ABSTRACT

A screwdriver including a handle, a mandrel shank, a mandrel, a bit holder, and a mandrel insert. The mandrel shank includes a first mandrel shank end coupled with the handle and a second mandrel shank end opposite the first mandrel shank end and having a first bayonet structure. The mandrel is at least partially positioned in the handle and movable relative to the handle along the mandrel shank. The mandrel includes a tip end selectively received in a mandrel receptacle of the handle. The mandrel insert is coupled to the second mandrel shank end and includes a second bayonet structure coupled to the first bayonet structure. The mandrel and the bit holder are movable between a retracted position and an extended position in which a bit retainer of the bit holder is accessible from an exterior of the handle.

### BACKGROUND

The present disclosure relates to a screwdriver, and more particularly to a screwdriver with multiple accessories stored therein.

Known screwdrivers capable of storing accessories provide adhesive connections between some components thereof. The adhesive may provide a loose connection between the components, which may degrade over time due to pressure applied to one or more of the components and/or environmental conditions of the screwdriver. For example, high temperatures may melt and weaken the connection provided by the adhesive.

### SUMMARY

In some aspects, the techniques described herein relate to a screwdriver including: a handle extending along a longitudinal axis and including a first handle end, a second handle end opposite the first handle end, and a mandrel receptacle, the handle defining an interior volume between the first end and the second end and the mandrel receptacle extending from the first end into the interior volume; a mandrel shank including a first mandrel shank end coupled with the handle, and a second mandrel shank end opposite the first mandrel shank end and having a first bayonet structure; a mandrel at least partially positioned in the handle and movable relative to the handle, the mandrel including a tip end selectively received in the mandrel receptacle, the mandrel being movable along the mandrel shank; a primary shank including a base end coupled to the handle and a distal end opposite the base end; a bit holder coupled with the mandrel, the bit holder including a bit retainer configured to receive one or more bits for storage therein, and a mandrel insert coupled to the second mandrel shank end, the mandrel insert including a second bayonet structure coupled to the first bayonet structure to secure the mandrel shank to the mandrel shank insert, wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

In some aspects, the techniques described herein relate to a screwdriver including: a handle extending along a longitudinal axis and including a first handle end, a second handle end opposite the first handle end, and a mandrel receptacle, the handle defining an interior volume between the first end and the second end and the mandrel receptacle extending from the first end into the interior volume; a mandrel shank coupled to the handle; a mandrel at least partially positioned in the handle and movable along the mandrel shank relative to the handle, the mandrel including a tip end selectively received in the mandrel receptacle, a mandrel outer surface with a first mandrel recess; a primary shank including a base end coupled to the handle and a distal end opposite the base end; a bit holder coupled with the mandrel, the bit holder including a bit retainer configured to receive one or more bits for storage therein, and a front mandrel stop including a mandrel stop inner surface and a front mandrel stop projection extending inward from the mandrel stop inner surface toward the longitudinal axis, the projection engaging the first mandrel recess to axially secure the front mandrel stop to the mandrel, wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

In some aspects, the techniques described herein relate to a screwdriver including: a handle extending along a longitudinal axis and including a first handle end, a second handle end opposite the first handle end, and a mandrel receptacle, the handle defining an interior volume between the first end and the second end and the mandrel receptacle extending from the first end into the interior volume; a mandrel shank coupled to the handle; a mandrel at least partially positioned in the handle and movable along the mandrel shank relative to the handle, the mandrel including a tip end selectively received in the mandrel receptacle and a mandrel outer surface with a first mandrel recess; a primary shank including a base end coupled to the handle and a distal end opposite the base end; a bit holder coupled with the mandrel, the bit holder defining a bit holder body with a bit holder outer surface and a bit holder inner surface, the bit holder further including a bit retainer on the body configured to receive one or more bits for storage and a bit holder projection extending radially inward from the bit holder inner surface toward the longitudinal axis, the bit holder projection engaging the first mandrel recess to axially secure the bit holder to the mandrel, and wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

Other aspects of the disclosure will become apparent by consideration of the detailed description and accompanying drawings.

### BRIEF DESCRIPTION OF THE DRAWINGS

FIG. 1 is a perspective view of a screwdriver embodying the disclosure.

FIG. 2 is a side view of the screwdriver of FIG. 1 including a bit holder in a retracted position.

FIG. 3 is a side view of the screwdriver of FIG. including the bit holder in an extended position.

FIG. 4 is a cross-section view of the screwdriver of FIG. 1 taken along line 4-4 in FIG. 2 and illustrating internal sections of the screwdriver.

FIG. 5 is an exploded view of the screwdriver of FIG. 1 including a handle, a mandrel, a first mandrel stop, a bit holder, a mandrel shank, a mandrel insert, a primary shank, a splinter, and a bit retainer.

FIG. 6 is an enlarged view of a portion of the screwdriver of FIG. 4 consistent with section 6-6 in FIG. 4.

FIG. 7 is an enlarged view of a portion of the screwdriver of FIG. 4 consistent with section 7-7 in FIG. 4.

FIG. 8 is an enlarged view of a portion of the screwdriver of FIG. 4 consistent with section 8-8 in FIG. 4.

FIG. 9 is a cross-section view of a handle of the screwdriver taken along line 9-9 in FIG. 5.

FIG. 10 is an end view of a front mandrel stop of the screwdriver of FIG. 1.

FIG. 11 is a cross-sectional view of the front mandrel stop of FIG. 10.

FIG. 12 is a side view of a mandrel of the screwdriver of FIG. 1.

FIG. 13 is a cross-sectional view of the mandrel of FIG. 12.

FIG. 14 is a side view of a bit holder of the screwdriver of FIG. 1.

FIG. 15 is an end view of the bit holder of FIG. 14.

FIG. 16 is a cross-sectional view of the bit holder of FIG. 14.

FIG. 17 is a side view of a mandrel insert of the screwdriver of FIG. 1.

FIG. 18 is a cross-sectional view of the mandrel insert of FIG. 17.

FIG. 19 is a side view of a shank, splinter, and bit retainer of the screwdriver of FIG. 1.

FIG. 20 is a cross-sectional view of the shank, splinter, and bit retainer of FIG. 19.

FIG. 21 is a perspective view of the splinter of FIG. 19.

FIG. 22 is a perspective view of an alternate splinter.

FIG. 23 is a side view of a mandrel shank of the screwdriver of FIG. 1.

FIG. 24 is a side view of an alternate mandrel shank.

FIG. 25 is a top view of the screwdriver of FIG. 1 illustrating texture surface treatment thereof.

FIG. 26 is a side view of the screwdriver of FIG. 1 illustrating texture surface treatment thereof.

FIG. 27 is a rear end view of the screwdriver of FIG. 1 illustrating texture surface treatment thereof.

FIG. 28 is a diagram illustrating dimensions of a microtexture surface treatment of the screwdriver of FIG. 1.

FIG. 29 is a diagram illustrating dimensions of a nanotexture surface treatment of the screwdriver of FIG. 1.

### DETAILED DESCRIPTION

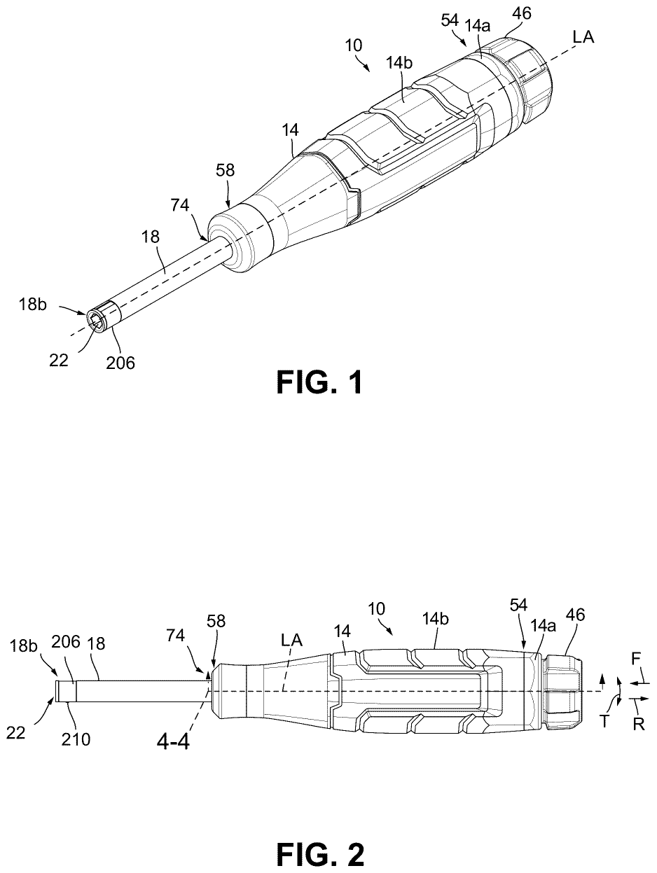

Before any examples of the disclosure are explained in detail, it is to be understood that the disclosure is not limited in its application to the details of construction and the arrangement of components set forth in the following description or illustrated in the drawings. The disclosure is capable of other examples and of being practiced or of being carried out in various ways. Any implementation described herein as “exemplary” is not necessarily to be construed as preferred or advantageous over other implementations. It will be apparent to those skilled in the art that modifications and variations can be made in the present technology without departing from the scope or spirit of the claimed technology. Also, it is to be understood that the phraseology and terminology used herein is for the purpose of description and should not be regarded as limiting. For example, while the example shown in FIG. 1 discloses a screwdriver, the disclosure includes application to other, similar types of tools.

The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, (e.g., clockwise or counterclockwise).

Benefits, other advantages, and solutions to problems are described below with regard to specific examples. However, the benefits, advantages, solutions to problems, and any feature(s) that may cause any benefit, advantage, or solution to occur or become more pronounced are not to be construed as a critical, required, or essential feature of any or all the claims.

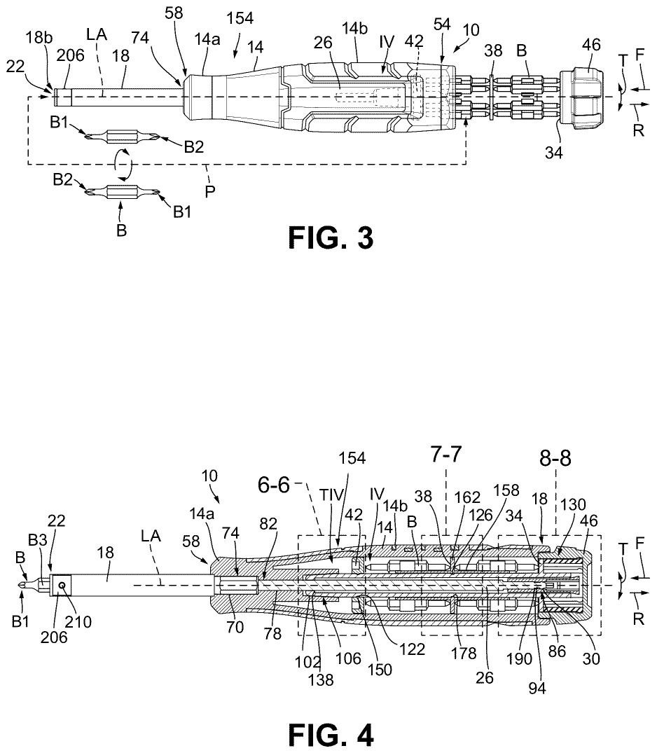

FIGS. 1-5 illustrate a screwdriver 10 (e.g., a precision screwdriver) with on-board bit storage. The screwdriver 10 includes a handle 14 oriented along a longitudinal axis LA, a primary shank 18 with a drive 22, a mandrel shank 26, a mandrel insert 30 coupled to the mandrel shank 26, and a mandrel 34 movable relative to the mandrel shank 26 between a retracted position and an extended position (as described in detail below), a bit holder 38 coupled to the mandrel 34, and a front mandrel stop 42 and cap 50 each coupled to and movable with the mandrel 34. The bit holder 38 includes a plurality of bit retainers 50 configured to selectively receive bits B for storage within the handle 14. The drive 22 of the primary shank 18 is non-circular in cross-sectional shape perpendicular to the longitudinal axis LA and is capable of directly engaging a working fastener (e.g., a non-circular head screw or the like, working fastener not shown). The drive 22 is capable of receiving different bits B that can engage and manipulate different-shaped working fasteners (e.g., a socket head screw with a torx, hexagonal, or otherwise-shaped fastener). The mandrel 34, the front mandrel stop 42, and the cap 50 are movable as a unit or carriage (e.g., a carousel) relative to the handle 14 between the retracted position and the extended position. The mandrel 34, the front mandrel stop 42, and the cap 50 are axially translatable together along the longitudinal axis LA between the retracted position (FIG. 2) in which the bit holder 38 is positioned within an interior volume IV of the handle 14, and the extended position (FIG. 3) in which the bit holder 38 and the bit retainers 50 (including any bits B) are accessible from an exterior of the handle 14. When the carriage is in the extended position, any of the bits B may be attached to or removed from any one of the bit retainers 50 (in a radial direction relative to the longitudinal axis LA).

With reference to FIG. 4, the handle 14 includes a rear end 18 and a front end 22 opposite the rear end 18. The handle 14 is oriented along the longitudinal axis LA. The handle 14 is shaped substantially annular about the longitudinal axis LA with the interior volume IV of the handle 14 formed between the front end 22 and the rear end 18.

The handle 14 may be formed with one or more subcomponents. In the illustrated example, the handle 14 is formed as an over-molded structure with an inner body part 14a and an outer body part 14b (FIG. 11). The outer body part 14b surrounds the inner body part 14a along a majority of an axial length of the handle 14 between the rear end 18 and the front end 22. The inner body part 14a may be exposed, in part, to an exterior of the handle 14 at the rear end 18 and the front end 22, and/or at any other portion of the handle 14. Other arrangements are possible. One or more of the inner body part 14a, the outer body part 14b, and the cap 50 may be provided with an ergonomic surface texture treatment to enhance user grip of the screwdriver 10.

With reference to FIG. 4, the front end 22 of the handle 14 includes a mandrel shank 26 that is coupled to, or configured to be removably coupled with, the primary shank 18. For example, the mandrel shank 26 is engageable with a base end 74 of the primary shank 18. The base end 74 of the primary shank 18 may have a cross-sectional shape perpendicular to the longitudinal axis LA that is compatible with a cross-sectional shape of a shank receptacle 70. For example, the base end 74 of the primary shank 18 and the shank receptacle 70 are hexagonal in cross-sectional shape perpendicular to the longitudinal axis LA. In other examples, the base end 74 and the shank receptacle 70 may have other corresponding cross-sectional shapes, even shapes that differ from one another. Such an arrangement permits rotational torque applied to the handle 14 to be transferred to the primary shank 18, the drive 22, and the bit B in the drive 22 to a working fastener. The primary shank 18 has a distal end 18b that is opposite the base end 74. The distal end 18b includes the drive 22.

The front end 22 of the handle 14 includes a mandrel shank receptacle 78 that is coupled to or configured to be removably coupled to the mandrel shank 26. The mandrel shank 26 extends generally from the front end 22 toward the rear end 18. During operation of the screwdriver 10, the mandrel shank 26 may be fixed to the handle 14 by connection with the mandrel shank receptacle 78.

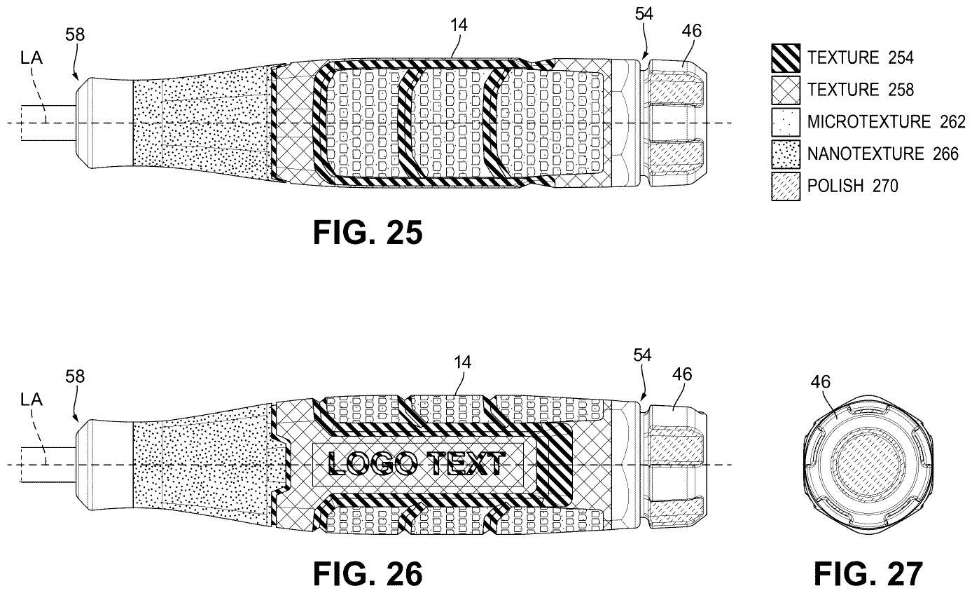

The mandrel shank 26 includes a mandrel shank front end 82 (i.e., a first mandrel shank end) coupled with the handle 14 via the mandrel shank receptacle 78 and a mandrel shank rear end 86 (i.e., a second mandrel shank end) coupled to the mandrel insert 30 (FIG. 4). The mandrel shank 26 may be generally cylindrical in shape and include a mandrel shank outer surface 90 (FIG. 25). In the illustrated example, the mandrel shank outer surface 90 is cylindrical in cross-sectional shape perpendicular to the longitudinal axis LA. The mandrel shank rear end 86 may be tapered about an angle AN5 relative to the longitudinal axis LA. The mandrel shank rear end 86 defines a radially extending shoulder 94. The mandrel shank outer surface 90 includes an annular groove 98 positioned adjacent the shoulder 94. The shoulder 94 and the groove 98 form a first bayonet structure that may engage a corresponding second bayonet structure of the mandrel insert 30.

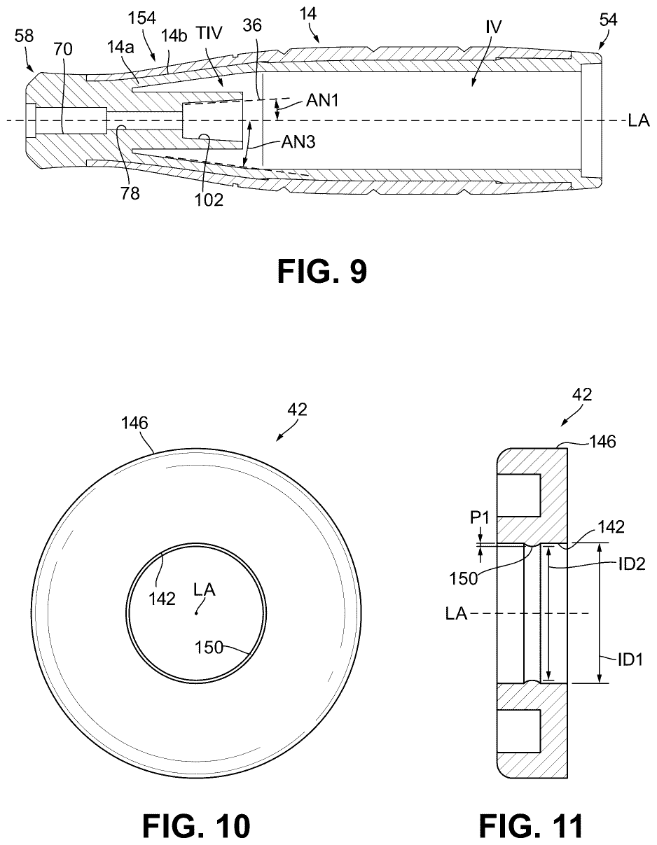

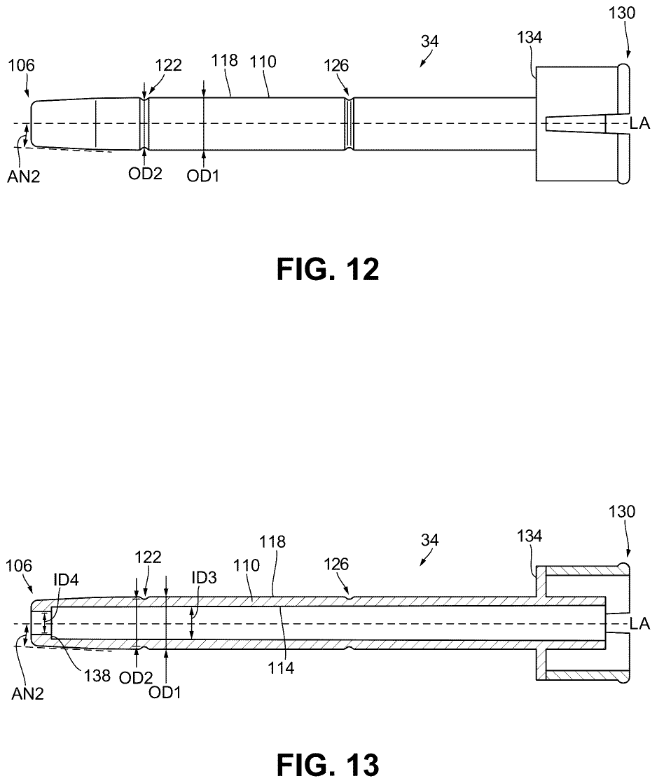

The mandrel 34 (FIG. 4) circumscribes (i.e., surrounds) the mandrel shank 26 about the longitudinal axis LA. The mandrel 34 (FIG. 12, FIG. 13) is at least partially annularly shaped, and includes a tip end 106 that is selectively received in a mandrel receptacle 102 of the handle 14 when the screwdriver 10 is in the retracted position. The mandrel receptacle 102 may be generally frusto-conically shaped about the longitudinal axis, with the frustoconical surface thereof being oriented along mandrel receptacle axis 36 provided at an angle AN1 relative to the longitudinal axis LA (FIG. 9). The mandrel receptacle 102 and the tip end 106 are dimensioned such that the mandrel 34 is configured to freely spin about the longitudinal axis LA within the mandrel receptacle 102 and with respect to the handle 14. With reference to FIG. 2, a user may, for example, with one hand, apply force in a forward direction F to the cap 50 to axially secure press the drive 22 onto a working fastener, and to with another hand or other fingers of the same hand, apply torque T to the handle 14 in a desired rotational direction about the longitudinal axis (i.e., clockwise or counterclockwise) to rotate the handle 14 and thus the primary shank 18 to transmit the torque T to the working fastener.

The tip end 106 may be tapered along an angle AN2 relative to the longitudinal axis LA (FIG. 15) with the tip end 106 being narrower than a mandrel body 110 of the mandrel 34. The mandrel body 110 is generally annularly shaped. The mandrel body 110 defines a mandrel body inner surface 114 and a mandrel body outer surface 118. In the illustrated example, both the mandrel body inner surface 14 and the mandrel body outer surface 118 are annular in cross-sectional shape perpendicular to the longitudinal axis LA. The mandrel 34 includes a pair of recesss 122, 126 in the mandrel body outer surface 118 which each extend from the mandrel body outer surface 118 radially inward toward the longitudinal axis LA (FIGS. 12, 13). In the illustrated example, the recesss 122, 126 extend circumferentially about the longitudinal axis LA around the entirety of the mandrel body outer surface 118. However, in other examples, the recesss 122, 126 may only extend circumferentially about the longitudinal axis LA along a portion of the mandrel body outer surface 118. The recesss 122, 126 are spaced from one another along the longitudinal axis LA. The illustrated mandrel body outer surface 118 is annular, and defines a mandrel outer diameter OD1. The recesss 122, 126 each define a mandrel recess outer diameter OD2 smaller than the outer diameter OD1 of the mandrel body outer surface 118. The illustrated mandrel body inner surface 114 is annular, and defines a mandrel body inner diameter ID3.

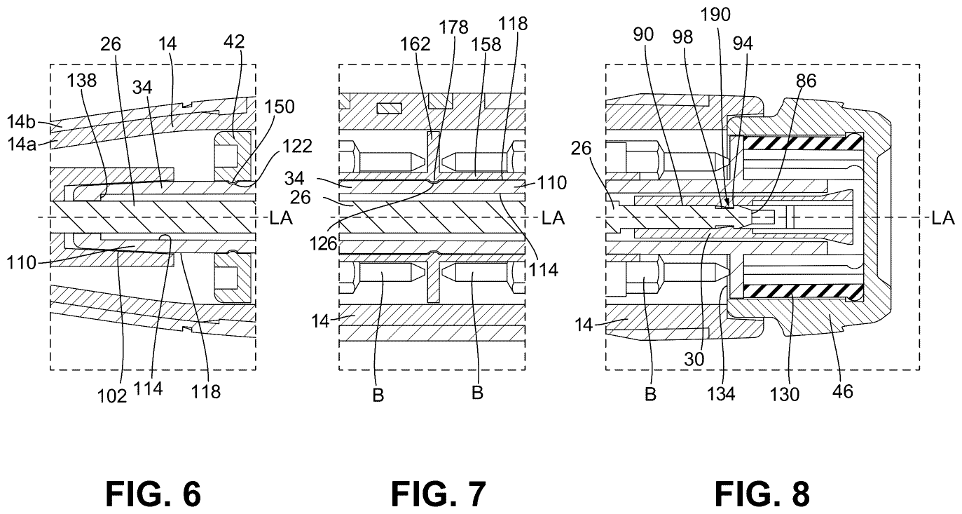

The mandrel 34 further includes a cap end 130 (FIG. 8) opposite the tip end 106 (FIG. 6). The cap end 130 is secured to the cap 50. The cap end 130 includes a cap shoulder 134 that inhibits access to bits B stored in the bit holder 38 in a direction parallel to the longitudinal axis when the mandrel 34 and bit holder 38 are in both the retracted position (FIG. 2) and the extended position (FIG. 3). In the extended position, bits B must be removed by movement away from the bit retainers 50 in a radially extending direction extending away from (i.e., radially outward from) the longitudinal axis LA. The bits B are inhibited from removal from the bit retainers 50 in a rearward direction R (FIG. 3) by the cap shoulder 134. The tip end 106 of the mandrel 34 defines a tip stop 138 with a mandrel tip inner diameter ID4 smaller than the mandrel body inner diameter ID3 of the mandrel body inner surface 114.

The front mandrel stop 42 (FIGS. 10, 11) is at least partially annular in shape about the longitudinal axis LA, and defines a front mandrel stop mandrel stop inner surface 142 and an outer surface 146. In the illustrated example, both the mandrel stop inner surface 142 and the outer surface 146 are generally annular in shape. The front mandrel stop 42 includes a front mandrel stop projection 150 extending radially inward from the mandrel stop inner surface 142 toward the longitudinal axis LA. The mandrel stop inner surface 142 defines a front mandrel stop inner diameter ID1, and the front mandrel stop projection 150 defines a projection inner diameter ID2 smaller than the front mandrel stop inner diameter ID1 by a projection length P1. The mandrel stop inner surface 142 is dimensioned to correspond with the mandrel outer diameter OD1 of the mandrel body outer surface 118 of the mandrel body 110 of the mandrel 34. The projection length P1 is dimensioned to correspond with the recess to facilitate engagement between the front mandrel stop projection 150 and the recess 122. The front mandrel stop projection 150 and recess 122 assist in axially securing the front mandrel stop 42 to the mandrel 34. The projection and recess 122 provide a strong, rigid, mechanical attaching structure in comparison to known designs which may simply include adhesive for attaching the front mandrel stop 42 to the mandrel 34.

With reference to FIGS. 3, 4, and 9, the handle 14 defines an inner tapered portion 154 adjacent the front end 22. The tapered portion 154 is tapered inward toward the longitudinal axis LA toward the front end 22 of the handle 14 such that the interior volume IV includes a tapered interior volume TIV. The tapered interior volume TIV is located positioned radially outward from the mandrel receptacle 102 between the mandrel receptacle 102 and the inner body part 14a. The outer surface 146 of the front mandrel stop 42 is engageable with the inner tapered portion 154 to inhibit over-retraction of the mandrel stop 42 and thus the mandrel 34 (e.g., in forward direction F) into the handle 14. The inner tapered portion 154 is oriented at an angle AN3 relative to the longitudinal axis LA. The angle AN3 may differ or be the same as the angle AN1 defined by the mandrel receptacle 102. The front mandrel stop 42 also may inhibit one or more bits B (e.g., any of the bits B retained in the bit retainers 50) from inadvertently passing into the tapered interior volume TIV. In the extended position (FIG. 3), the front mandrel stop 42 may be positioned within the interior volume IV of the handle 14.

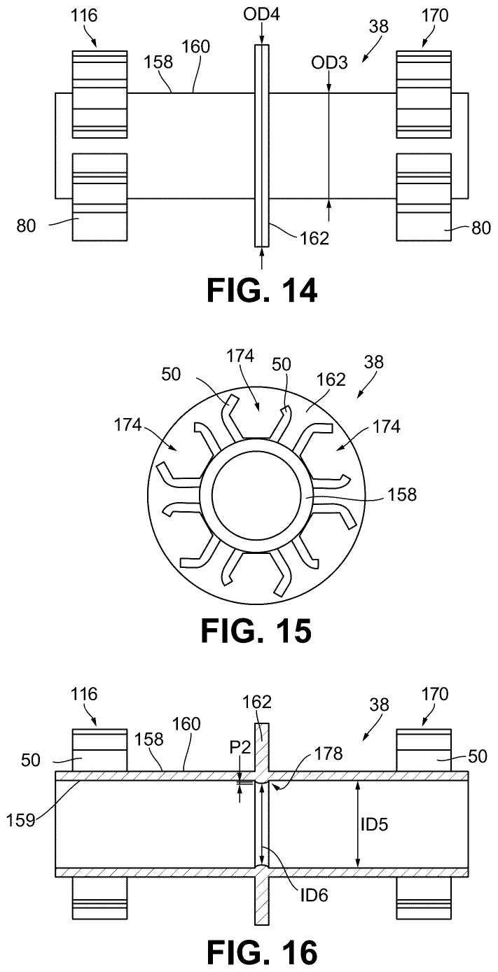

FIGS. 14-16 illustrate that the bit holder 38 includes a bit holder body 158 that is annular in cross-section taken across or perpendicular to the longitudinal axis LA. The bit holder body 158 includes a bit holder inner surface 159 and a bit holder outer surface 160. The bit holder inner surface 159 is at least partially annular in shape when viewed perpendicular to the longitudinal axis LA. The bit holder inner surface 159 has an inner diameter ID5. The bit holder outer surface 160 is at least partially annular in shape when viewed perpendicular to the longitudinal axis LA. The bit holder outer surface 160 has a bit holder outer diameter OD3. A divider 162 extends radially outward from the bit holder outer surface 160. The divider 162 defines a divider outer diameter OD4 nominally greater than the bit holder outer diameter OD3. The bit holder 38 includes a first or front bit retainer group 116 and a second or rear bit retainer group 170 on opposite sides of the divider 162. Each bit retainer group 116, 170 includes a plurality of bit retainers 50 that extend outward from the bit holder outer surface 160 and are dimensioned to receive a bit B. In the illustrated example, the bit retainers 50 each include two arms which oppose one another to define a receptacle 174 dimensioned to receive a bit B with a shank B3 of hexagonal cross section. In the illustrated example, the bit retainers 50 do not entirely surround (e.g., around 360 degrees thereof) the shank B3 when the bit B is coupled thereto. Other shapes are possible. The bit holder 38 further includes a bit holder projection 178 having a projection length P2 and defining an inner diameter ID6 that is smaller than the inner diameter ID5 of the bit holder inner surface 159. The bit holder inner surface 159 is dimensioned to correspond with the mandrel body outer surface 118, and the bit holder projection 178 is dimensioned to engage the recess 126 (FIG. 7). As such, the bit holder projection 178 is configured to axially secure the bit holder 38 to the mandrel 34. In the illustrated example, the divider 162 is radially outboard of the bit holder projection 178 at an axial position aligned with the bit holder projection 178. The bit holder projection 178 and recess 122 provide a strong, rigid, mechanical attaching structure in comparison to known design which may simply include adhesive for attaching the bit holder 38 to the mandrel 34.

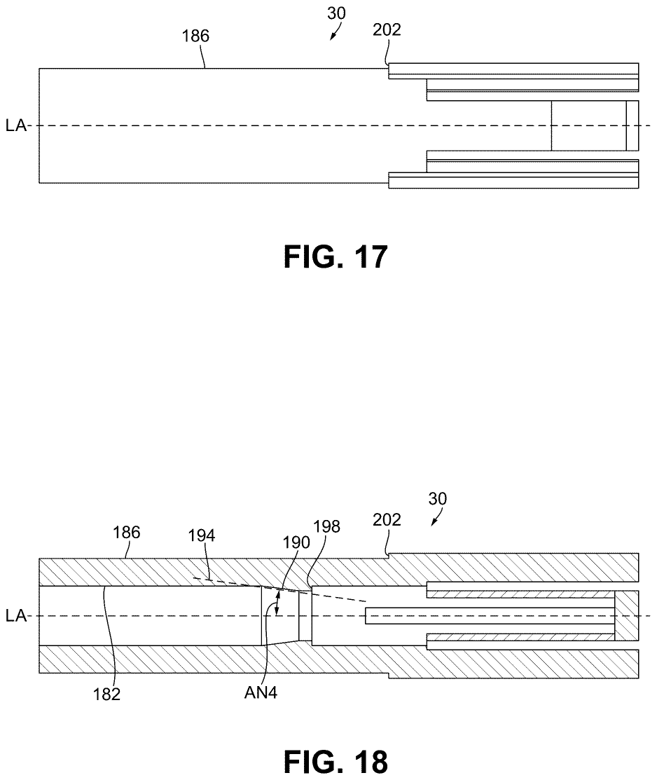

FIGS. 17 and 18 illustrate the mandrel insert 30 as including a mandrel insert inner surface 182 and a mandrel insert outer surface 186. In the illustrated example, the mandrel insert 30, including the mandrel insert inner surface 182 and the mandrel insert outer surface 186, are annular in cross-sectional shape when viewed perpendicular to the longitudinal axis LA. The mandrel insert 30 includes a tapered wall 190 that functions as a second bayonet structure for engaging the first bayonet structure formed by the shoulder 94 and the groove 98 of the mandrel shank 26. The tapered wall 190 is oriented along a wall axis 194 that is angled relative to the longitudinal axis LA by an angle AN4. The tapered wall 190 further defines step 198 engageable with the shoulder 94 to secure the mandrel insert 30 to the mandrel shank rear end 86. The mandrel insert 30 further includes a stop 202 extending outward from the mandrel insert outer surface 186. The stop 202 is configured to interact with the mandrel 34, more specifically the tip stop 138 to selectively inhibit removal of the mandrel tip end 106 from the interior volume IV of the handle 14 upon extension of the mandrel 34 along reverse direction R. Upon typical extension (e.g., typical amount of force to retract the mandrel 34 and cap from the handle 14) of the mandrel 34 along the reverse direction R, the stop 202 interacts with the tip stop 138. When desired to fully remove the mandrel 34 from the handle 14, additional axial force in reverse direction R and/or torque T about the longitudinal axis LA may be applied to the cap 50, and the mandrel 34 may be removed from the handle 14 by passing and/or carrying with it the mandrel insert 30. The stop 202 and tip stop 138 provides a strong, rigid, mechanical attaching structure in comparison to known designs which may simply include adhesive for attaching the mandrel insert 30 to the mandrel shank 26.

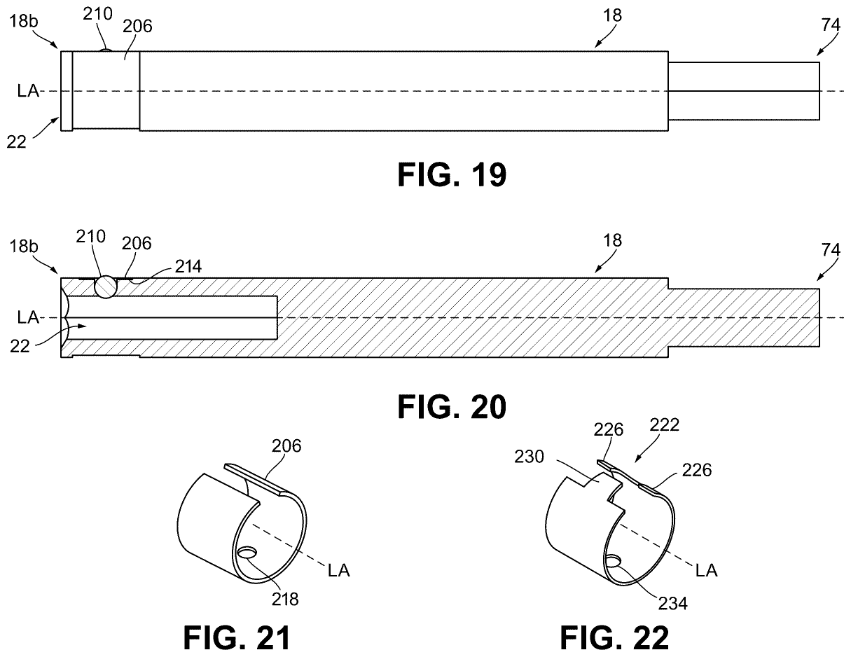

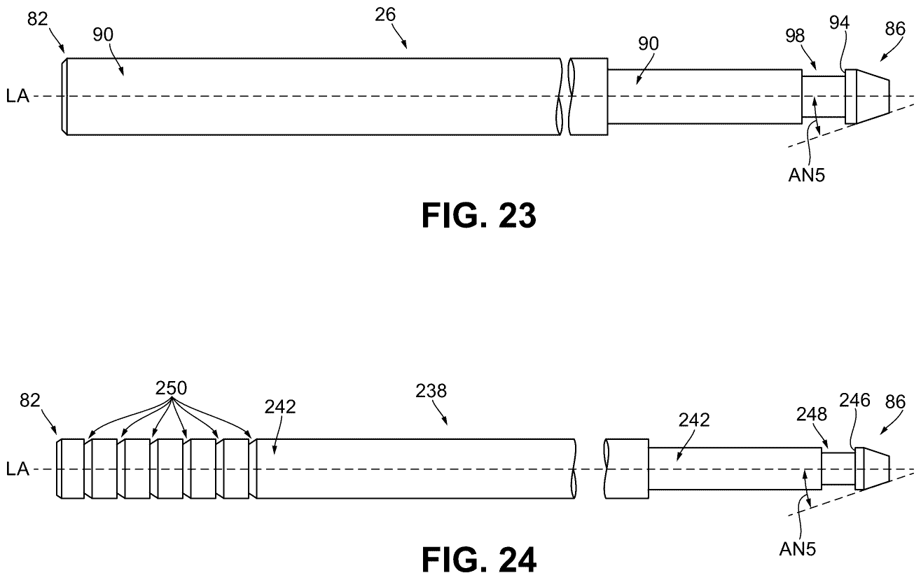

FIGS. 19-22 illustrate the primary shank 18 in detail, and further illustrate a splinter 206 and bit retainer 210 capable of securing a bit B to the drive 22. In the example illustrated in FIG. 23, the splinter 206 is generally cylindrical about longitudinal axis LA, and does not extend a full circumferential revolution around the longitudinal axis LA. As such, the splinter 206 is attachable to a splinter groove 214 near the distal end 18b of the primary shank 18. The splinter 206 includes a hole 218, and may include a biasing mechanism (not shown) for biasing the bit retainer 210 (e.g., ball bearing) into engagement with the bit B to retain an axial position of the bit B in the drive 22. In the example of FIG. 24, an alternate splinter 222 is illustrated. The alternate splinter 222 includes a pair of splines 226 on one circumferential side thereof, and a single spline 230 on an opposite circumferential side thereof, with the entirely of the alternate splinter 222 also being generally cylindrical but not extending a full amount around the longitudinal axis LA. The alternate splinter 222 further includes a hole 234 similar to the hole 218.

FIG. 23 illustrates that the mandrel shank rear end 86 of the mandrel shank 26 may be tapered about an angle AN5 relative to the longitudinal axis LA. FIG. 24 illustrates another mandrel shank 238 including an outer surface 242, a shoulder 246, and an annular groove 248 similar to that of the mandrel shank 26. The alternate mandrel shank 238 may include a plurality of circumferentially extending raceways 250. The raceways 250 are spaced from one another along the longitudinal axis L and may assist in securing the alternate mandrel shank 238 to the mandrel shank receptacle 78 of the handle 14.

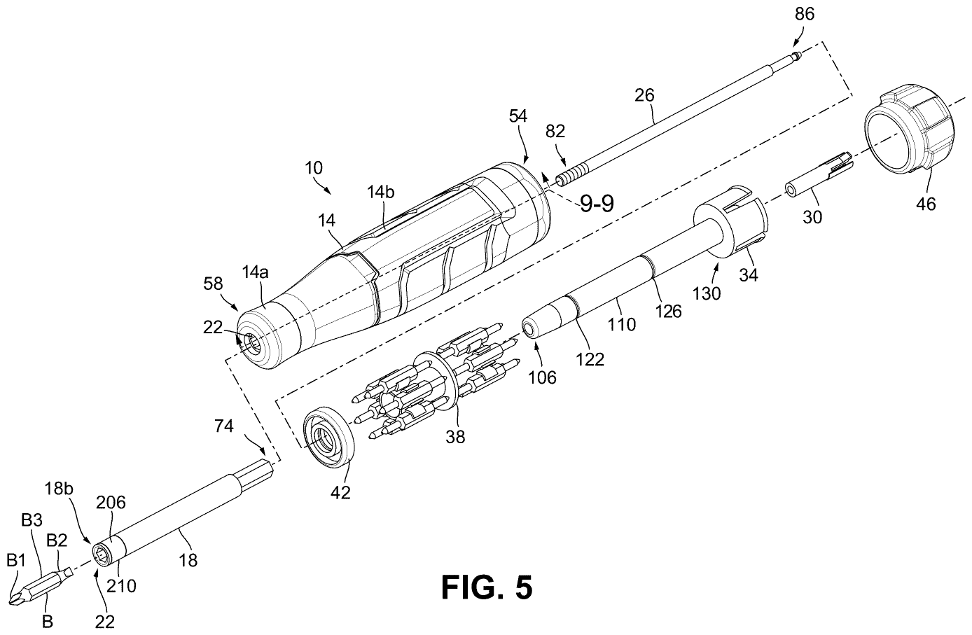

FIGS. 3 and 5 illustrate a plurality of bits B that may be used with the screwdriver 10. Each bit B optionally may be a double-sided bit including a first working end B1, a second working end B2 opposite the first working end B1, and a shank B3 that is disposed between the first working end B1 and the second working end B2. The first working end B1 and the second working end B2 of the same bit B may differ in size and/or shape so the be operable to transmit torque to differing fasteners. Each bit B may have an engraving or other indicator to indicate the size and/or shape of the each working end B1, B2. As illustrated in FIG. 5, the engraving or other indicator (e.g., “PH2”, “SL3”, etc.) may be located on the shank B3 adjacent the corresponding working end B1, B2. The bit B may be passed along a path P

In the illustrated example, the front bit retainer group 116 and the rear bit retainer group 170 each include six bit retainers 50. Each bit retainer 50 is capable of engaging a bit B that is double-sided including two working ends B1, B2. The working ends B1, B2 of the same bit B may differ from one another. Each bit B may include shank B3 that is compatible in cross-sectional geometry with the drive 22. Counting the drive 22 itself as capable of directly contacting and driving a fastener, the screwdriver 10 as a whole may be capable of driving twenty seven types of fasteners. More or fewer bit retainers 50 may be present, and not all the bits B need be double-sided bits B. As a result, more or fewer than twenty seven types of fasteners may be driven by the screwdriver 10.

The cap 50, mandrel 34, and bit holder 38 are movable between the retracted position (FIG. 2) whereby the mandrel 34 is received in the mandrel receptacle 102 and the bit holder 38 is positioned within the interior volume IV of the handle 14 and the extended position (FIG. 3) whereby the mandrel 34 is removed from the mandrel receptacle 102 and the bit retainer 50 of the bit holder 38 is accessible from an exterior of the handle 14. The front mandrel stop 42 may also be movable as a unit (i.e., a “carriage” or “carousel”) with the cap 50, mandrel 34, and bit holder 38. The entire unit including the front mandrel stop 42, cap 50, mandrel 34, and bit holder 38 may be, as a unit, both translatable along the longitudinal axis LA and rotatable about the longitudinal axis. From the extended position, one or more bits B are alternately attachable to the drive 22 and any one of the bit retainers 50 by passing along path P (FIG. 3). While being moved between drive 22 and the bit retainer 50, the bit B can be flipped in orientation such that a desired working end B1, B2 protrudes form the drive 22 when secured to the primary shank 18.

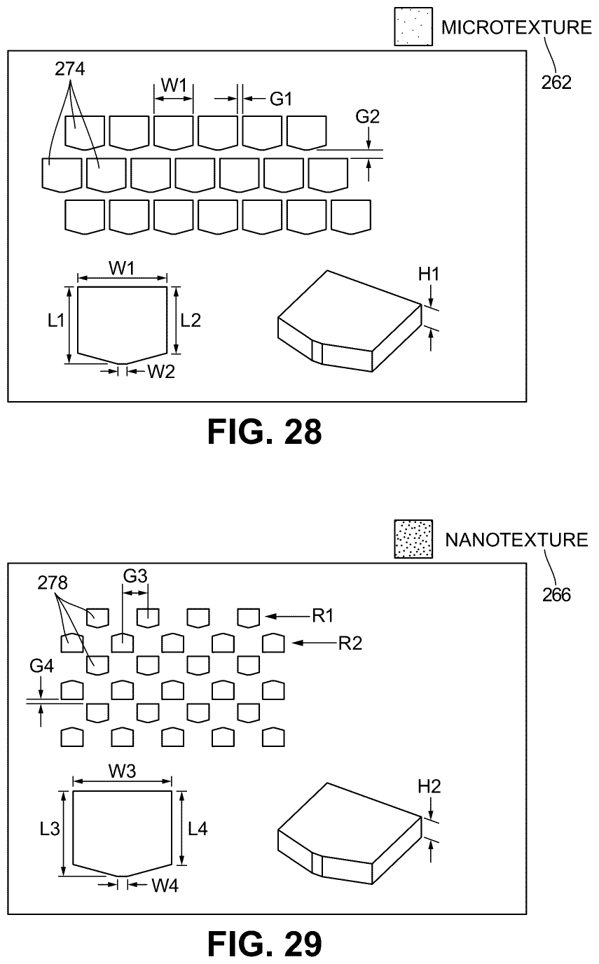

FIGS. 25-29 illustrate surface finishing of the handle 14 and cap 50. Various textures 254, 258, micro-textures 262, nanotextures 266, polishes 270 (simplified as textures 254-270), and the like my be applied to the handle 14 (including the inner body part 14a and the outer body part 14b) and the cap 50 to enhance user grip of the screwdriver 10. FIGS. 25-27 illustrate an exemplary arrangement of the various textures 254-270. As illustrated in detail in FIG. 28 the microtexture 262 may include a plurality of shield shapes 274 arranged in an array pattern. Each shield shape 274 may define a full width W1, a partial width W2 nominally lesser than the full width W1, a full length L1, a partial length L2 nominally lesser than the full length L1, and a height H1 to project from a surface that the microtexture 262 is applied to. In the illustrated example, each of the shield shapes 274 are oriented in the same way as spaced in differing columns by a gap G1 and different rows by a gap G2. The partial width W2 of one row may be aligned with the gap G1 of a different row. Similarly, FIG. 29 illustrates nanotexture 266 as including a plurality of shield shapes 278 arranged in an array pattern. Each shield shape 278 may define a full width W3, a partial width W4 lesser than the full width W3, a full length L3, a partial length L4 nominally lesser than the full length L3, and a height H2 to project from a surface that the nanotexture 266 is applied to. In the illustrated example, each of the shield shapes 278 of the same row R1, R2 are oriented in the same way, but the shield shapes 278 of alternating rows R1, R2 are oriented as opposing one another. Gaps G3 are present laterally between differing columns, and gaps G4 are present vertically between rows R1, R2. In the illustrated example each of the aforementioned dimensions of the nanotexture are smaller than the microtexture 262.

Although aspects of the disclosure have been described in detail with reference to certain preferred examples, variations and modifications exist within the scope of one or more independent aspects as described.

Various features and advantages of the disclosure are set forth in the following claims.

1. A screwdriver comprising:
a handle extending along a longitudinal axis and including a first handle end, a second handle end opposite the first handle end, and a mandrel receptacle, the handle defining an interior volume between the first end and the second end and the mandrel receptacle extending from the first end into the interior volume;
a mandrel shank including a first mandrel shank end coupled with the handle, and a second mandrel shank end opposite the first mandrel shank end and having a first bayonet structure;
a mandrel at least partially positioned in the handle and movable relative to the handle along the mandrel shank, the mandrel including a tip end selectively received in the mandrel receptacle;
a primary shank including a base end coupled to the handle and a distal end opposite the base end;
a bit holder coupled with the mandrel, the bit holder including a bit retainer configured to receive one or more bits for storage, and
a mandrel insert coupled to the second mandrel shank end, the mandrel insert including a second bayonet structure coupled to the first bayonet structure to secure the mandrel shank to the mandrel shank insert,
wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

2. The screwdriver of claim 1, further comprising a front mandrel stop that is annular in shape about the longitudinal axis, the front mandrel stop defining a mandrel stop inner surface and a front mandrel stop projection extending inward from the mandrel stop inner surface toward the longitudinal axis, wherein the mandrel is annular in shape about the longitudinal axis and defines a mandrel body outer surface with a first recess, and wherein the front mandrel stop projection engages the first recess of the mandrel to axially secure the front mandrel stop to the mandrel.

3. The screwdriver of claim 2, wherein the bit holder includes an annular body with a bit holder outer surface and a bit holder inner surface, and a bit holder projection extending radially inward from the inner surface toward the longitudinal axis, wherein the mandrel body outer surface further includes a second recess extending inward toward the longitudinal axis, and wherein the bit holder projection engages the second recess of the mandrel to axially secure the bit retainer to the mandrel.

4. The screwdriver of claim 1, wherein the second mandrel shank end defines a shoulder functioning as the first bayonet structure.

5. The screwdriver of claim 4, wherein the mandrel shank is cylindrical in shape and includes a mandrel shank outer surface, the mandrel shank outer surface including a groove, the shoulder positioned adjacent the groove.

6. The screwdriver of claim 1, wherein the mandrel insert is annular in shape about the longitudinal axis and includes a mandrel insert inner surface, the second bayonet structure being a tapered wall extending inward from the mandrel insert inner surface toward the longitudinal axis.

7. The screwdriver of claim 1, wherein the mandrel insert is annular in shape about the longitudinal axis and includes a mandrel insert outer surface, the mandrel insert annular outer surface defining a stop extending outward from the mandrel insert outer surface, the stop configured to interact with the mandrel to selectively inhibit removal of the mandrel tip end from the interior volume of the handle.

8. The screwdriver of claim 7, wherein the mandrel is annular in shape about the longitudinal axis and includes a mandrel body inner surface, the tip end defining a tip stop extending inward from the mandrel body inner surface toward the longitudinal axis, the tip stop configured to interact with the stop of the mandrel insert.

9. The screwdriver of claim 1, wherein in the retracted position, the mandrel is axially received within the mandrel receptacle and the mandrel is configured to freely spin within the mandrel receptacle and with respect to the handle.

10. A screwdriver comprising:
a handle extending along a longitudinal axis and including a first handle end, a second handle end opposite the first handle end, and a mandrel receptacle, the handle defining an interior volume between the first end and the second end and the mandrel receptacle extending from the first end into the interior volume;
a mandrel shank coupled to the handle;
a mandrel at least partially positioned in the handle and movable along the mandrel shank relative to the handle, the mandrel including a tip end selectively received in the mandrel receptacle and a mandrel outer surface with a first mandrel recess;
a primary shank including a base end coupled to the handle and a distal end opposite the base end;
a bit holder coupled with the mandrel, the bit holder including a bit retainer configured to receive one or more bits for storage therein; and
a front mandrel stop including a mandrel stop inner surface and a front mandrel stop projection extending inward from the mandrel stop inner surface toward the longitudinal axis, the projection engaging the first mandrel recess to axially secure the front mandrel stop to the mandrel,
wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

11. The screwdriver of claim 10, wherein
the bit holder includes a bit holder body with a bit holder outer surface and a bit holder inner surface, the bit holder body including a bit holder projection extending radially inward from the bit holder inner surface toward the longitudinal axis,
the mandrel outer surface further includes a second recess, and
the bit holder projection engages the second recess of the mandrel outer surface to axially secure the bit retainer to the mandrel.

12. The screwdriver of claim 10, wherein the front mandrel stop is movable with the mandrel between the retracted position and the extended position.

13. The screwdriver of claim 10, wherein handle includes a tapered portion adjacent the tip end, the tapered portion being tapered toward the longitudinal axis toward the front end of the handle with the interior volume defining a tapered interior volume.

14. The screwdriver of claim 13, wherein the tapered interior volume is positioned radially outward from the mandrel receptacle.

15. The screwdriver of claim 14, wherein the front mandrel stop contacts the tapered portion upon retraction of the mandrel toward the retracted position to inhibit over-retraction of the mandrel into the handle and to inhibit the bit from passing into the tapered interior volume.

16. A screwdriver comprising:
a handle extending along a longitudinal axis and including a first handle end, a second handle end opposite the first handle end, and a mandrel receptacle, the handle defining an interior volume between the first end and the second end and the mandrel receptacle extending from the first end into the interior volume;
a mandrel shank coupled to the handle;
a mandrel at least partially positioned in the handle and movable along the mandrel shank relative to the handle, the mandrel including a tip end selectively received in the mandrel receptacle and a mandrel outer surface with a first mandrel recess;
a primary shank including a base end coupled to the handle and a distal end opposite the base end;
a bit holder coupled with the mandrel, the bit holder defining a bit holder body with a bit holder outer surface and a bit holder inner surface, the bit holder further including a bit retainer on the bit holder body configured to receive one or more bits for storage and a bit holder projection extending radially inward from the bit holder inner surface toward the longitudinal axis, the bit holder projection engaging the first mandrel recess to axially secure the bit holder to the mandrel, and
wherein the mandrel and the bit holder are movable between a retracted position in which the mandrel is positioned in the mandrel receptacle and the bit holder is positioned within the interior volume and an extended position in which the mandrel extends outward from the handle such that at least a portion of the bit retainer is accessible from an exterior of the handle.

17. The screwdriver of claim 16, wherein the bit holder includes a divider extending outward from the bit holder outer surface radially outboard of and at a position axially aligned with the bit holder projection, wherein the bit retainer is a first bit retainer on a first side of the divider and configured to receive one or more bits, and wherein the bit holder further includes a second bit retainer on a second side of the divider, the second bit retainer configured to receive one or more bits.

18. The screwdriver of claim 17, wherein the bit holder includes a plurality of first bit retainers arranged circumferentially about the longitudinal axis on the first side of the divider forming a first bit retainer group, wherein each of the first bit retainers can receive at least one bit for storage.

19. The screwdriver of claim 18, wherein the bit holder includes a plurality of second bit retainers arranged circumferentially about the longitudinal axis on the second side of the divider forming a second bit retainer group, wherein each of the first bit retainers and each of the second bit retainers can receive at least one bit for storage, and the distal end of the shank is configured to selectively directly contact a fastener or receive at least one of the bits with the bit being capable of direct contact with the fastener.

20. The screwdriver of claim 16, wherein the mandrel includes a cap end opposite the tip end, the cap end of the mandrel including a cap shoulder that inhibits access to the bit in a direction parallel to the longitudinal axis when the mandrel and bit holder are in both the retracted position and the extended position.
